(19) United States
(12) Patent Application Publication
(10) Pub. No.: US 2026/0319261 A1
(43) Pub. Date: Oct. 15, 2026

(54) MODULAR DISPLAY ASSEMBLIES FOR USE IN AUGMENTED-REALITY GLASSES DEVICES

(71) Applicant: Meta Platforms Technologies, LLC, Menlo Park, CA (US)

(72) Inventors: Christopher Tomasetta, Kirkland, WA (US); Jason Victor Tsai, Bellevue, WA (US)

(21) Appl. No.: 19/574,137

(22) Filed: Mar. 20, 2026

Related U.S. Application Data
(60) Provisional application No. 63/775,973, filed on Mar. 21, 2025.

(51) Int. Cl. G02B 27/01

(52) U.S. Cl. CPC G02B 27/0176; G02B 27/0172; G02B 27/0179; G02B 2027/0118; G02B 2027/0187

(57) ABSTRACT

A display assembly including one or more lenses, one or more electronic components, and a modular mounting system. The one or more lenses and the one or more electronic components are configured to present an augmented-reality (AR) experience at a pair of AR glasses. The modular mounting system is configured to allow the display assembly to be inserted into a lens frame of a first type having a first shape and into a lens frame of a second type having a second shape that is different from the first shape.

### CROSS REFERENCE TO RELATED APPLICATIONS

This present application claims the benefit of priority under 35 U.S.C. § 119(e) to U.S. Provisional Application No. 63/775,973, filed Mar. 21, 2025, the disclosure of which is hereby incorporated by reference in its entirety for all purposes.

### TECHNICAL FIELD

This relates generally to mixed reality (MR) devices and particularly to modular display assemblies that are configured for use in varying augmented-reality (AR) devices.

### BACKGROUND

Conventional mounting of display assemblies for AR glasses is integrated such that the display assembly cannot be assembled and/or disassembled separately from the AR glasses. For example, conventional display assemblies are not fully assembled and operational until installed into the AR glasses, and thus cannot be tested and/or validated until after installation. Additionally, conventional display assemblies are generally not modular and cannot be interchanged between frames of different AR glasses.

### SUMMARY

In some aspects, the subject technology is directed to a display assembly comprising one or more lenses, one or more electronic components, and a modular mounting system to allow the display assembly to fit into different lens frames of different types. The one or more lenses and one or more electronic components are configured to present an augmented-reality experience at an extended-reality (XR) device.

In other aspects, the subject technology is directed to an AR device comprising a display assembly that includes a lens stack including one or more lenses, one or more electronic components configured to process images from the lens stack to present an augmented-reality experience, and a modular mounting system configured to allow the display assembly to fit into different lens frames of different types.

In yet other aspects, the subject technology is directed to a method comprising providing a first portion of a lens frame, inserting a display assembly into the first portion of the lens frame, and mounting a second portion of the lens frame to the first portion of the lens frame. The first portion of a lens frame and the second portion of the lens frame are configured to secure the display assembly within an XR device. The display assembly includes one or more lenses and one or more electronic components configured to present an XR reality at the XR device, and a modular mounting system configured to allow the display assembly to fit into a lens frame of a first type and a lens frame of a second type.

The features and advantages described in the specification are not necessarily all-inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1B illustrate examples of a display assembly mounted to a lens frame of a first type and a lens frame of a second type, respectively, for AR glasses, in accordance with some embodiments.

FIG. 2 illustrates an example of locating features for alignment of the display assembly and lens frames of the AR glasses, in accordance with some embodiments.

FIG. 3 illustrates an example of a lens stack of the display assembly, in accordance with some embodiments.

FIG. 4 shows an example method flow chart of a method of manufacturing a pair of AR glasses, in accordance with some embodiments.

FIGS. 5A, 5B, 5C-1, and 5C-2 illustrate example MR and AR systems, in accordance with some embodiments.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

In some aspects, the subject technology is directed to a modular display assembly that is configured to: (i) be tested prior to installation for quality control and (ii) be modular in design to fit multiple frame sizes and shapes without needing to have different display assemblies for shapes having different sizes and shapes. One example of a pair of AR glasses is described herein. This example pair of AR glasses includes one or more lenses, one or more electronic components, and a modular mounting system. The one or more lenses and one or more electronic components are configured to present an AR experience at a pair of AR glasses. Furthermore, the modular mounting system is configured to allow the display assembly to be inserted into a lens frame of a first type having a first shape and inserted into a lens frame of a second type having a second shape that is different from the first shape. For example, the lens frame of the first type is a metal-type frame, and the lens frame of the second type is a plastic-type frame.

In some embodiments, the lens frame of the first type is configured to secure the first display assembly within a first pair of AR glasses and the lens frame of the second type is configured to secure the first display assembly within a second pair of AR glasses distinct from the first pair of AR glasses. The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive list of electronic devices that can, either alone or in combination (e.g., a system), include instructions that cause the performance of methods and operations associated with the presentation and/or interaction with an XR experience includes an XR headset (e.g., an MR headset) or a pair of AR glasses as two examples, a wrist-wearable device, an intermediary processing device, a smart textile-based garment, etc. For example, when an XR headset is described, it is understood that the XR headset can be in communication with one or more other devices (e.g., a wrist-wearable device, a server, and/or an intermediary processing device) that together can include instructions for performing methods and operations associated with the presentation and/or interaction with an XR system. For example, the XR headset would be part of a system that includes one or more additional devices. Multiple combinations with different related devices are envisioned but not recited for brevity.

Embodiments of this disclosure can include or be implemented in conjunction with various types of extended-realities (XRs) such as mixed-reality (MR) and AR systems.

### Modular Display Assemblies

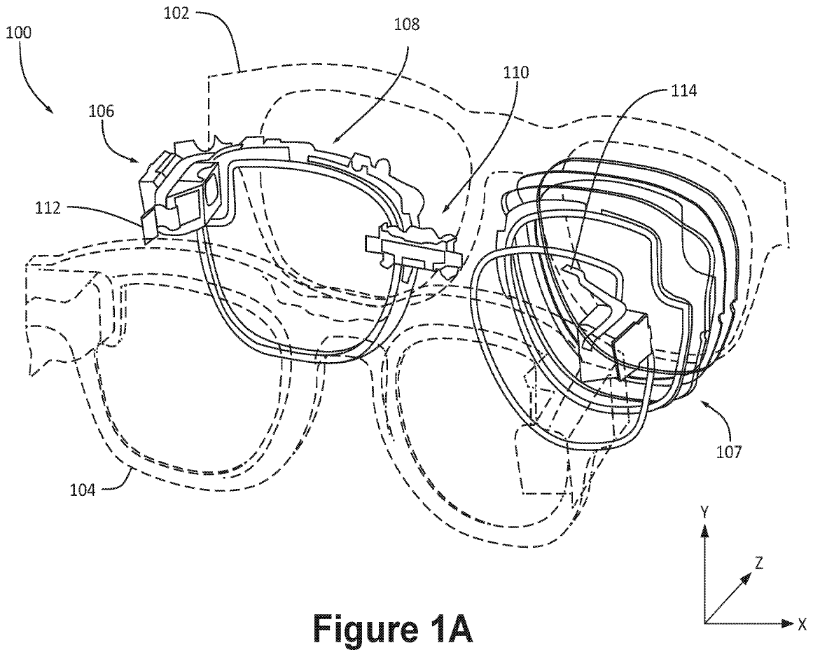

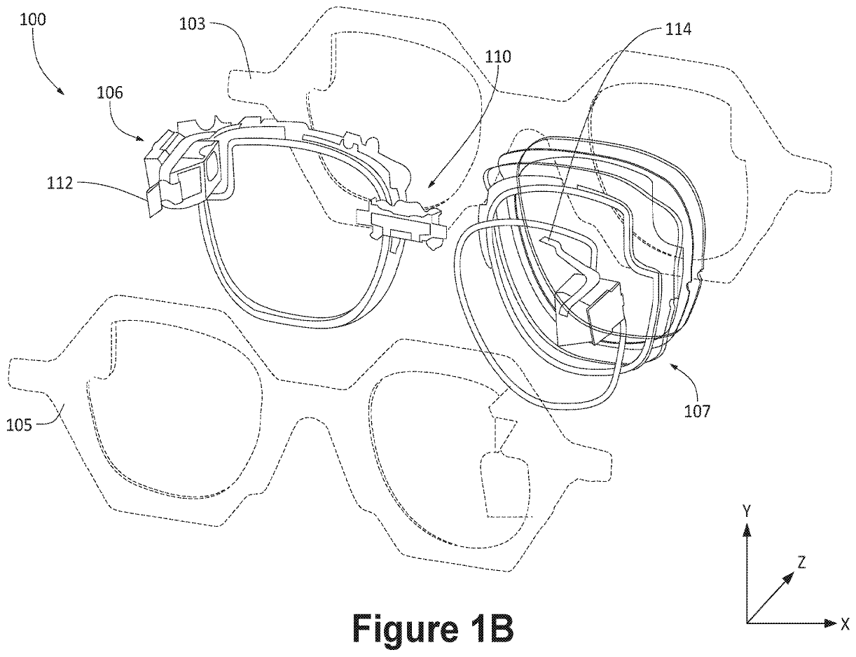

FIGS. 1A-1B illustrate examples of a display assembly mounted to a lens frame of a first type (e.g., front lens frame 102 and rear lens frame 104) and a lens frame of a second type (e.g., front lens frame 103 and rear lens frame 105), respectively, for AR glasses 100, in accordance with some embodiments. As shown in FIG. 1A, the AR glasses 100 include a front lens frame 102 that is configured to couple to a rear lens frame 104, and in FIG. 1B, the AR glasses 100 include a front lens frame 103 (distinct from front lens frame 102) that is configured to couple to a rear lens frame 105 (distinct from rear lens frame 104). The AR glasses 100 further include a display assembly 108 that is configured to couple to the front lens frame 102 and the rear lens frame 104.

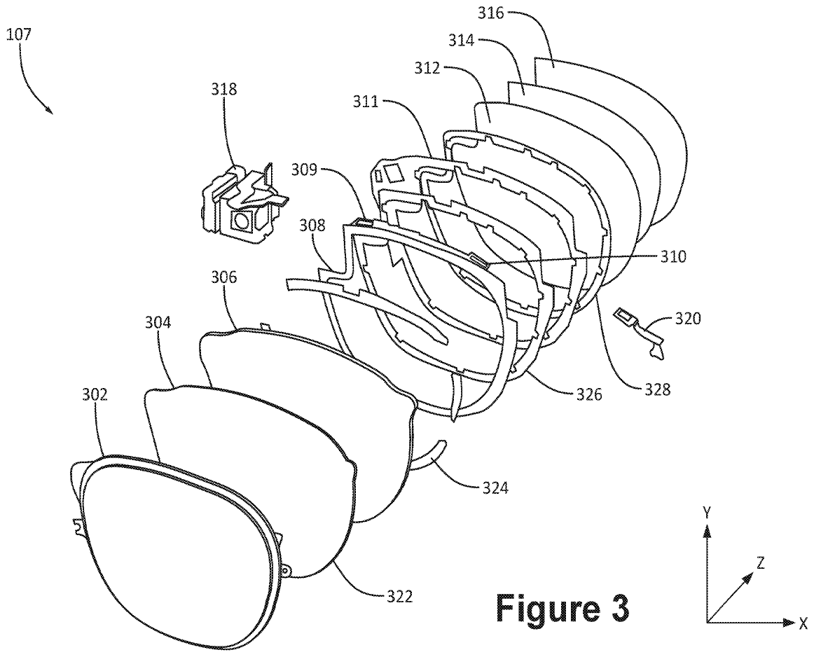

As shown in FIG. 1A, in an exploded view, the display assembly 108 includes a display projector assembly 106 and a lens stack 107 (which is described in more detail with respect to FIG. 3).

In some embodiments, the display assembly 108 is modular, thereby allowing the display assembly to be coupled to varying lens frames. In addition to being modular to fit in different frames, the display assembly 108 is also configured to be fully assembled separately from the rest of the AR glasses 100. Since the display assembly 108 is assembled separately, the display assembly 108 can be tested and/or validated without testing and/or validation of the entire AR glasses. Furthermore, such testing and/or validation can occur earlier in the manufacturing process.

As shown in FIG. 1A, the fully assembled display assembly 108 is then mounted to the front lens frame 102 and the rear lens frame 104. The display projector assembly 106 includes a first connector 112 and a second connector 114. The first connector 112 and the second connector 114 are configured to couple to other components of the AR glasses 100. For example, the first connector 112 and/or the second connector 114 are configured to enable power and data transfer between the display projector assembly 106 and other components of the AR glasses.

In some embodiments, the AR glasses 100 include a disparity sensor assembly 110. The disparity sensor assembly 110 is configured to couple to the modular display assembly 108 and/or another modular display assembly. The disparity sensor assembly 110 may also be configured to couple to the front lens frame 102 and/or the rear lens frame 104. In some embodiments, the disparity sensor assembly 110 is also modular, and its functionality can also be checked prior to final assembly of the AR glasses 100.

In some embodiments, the display projector assembly 106 is coupled to the front lens frame 102 and/or the rear lens frame 104 such that heat is transferred from the display projector assembly 106 to other parts of the AR glasses 100 (e.g., to the frame, arms, or other portions of the glasses that can act as a heat sink). The display projector assembly 106 can be coupled to the front lens frame 102 and/or the rear lens frame 104 via a thermally conductive material (e.g., a thermally conductive pad and/or paste).

As shown in FIG. 1B, in an exploded view, the fully assembled display assembly 108 that can be mounted in the front lens frame 102 and the rear lens frame 104 (as shown in FIG. 1A) can also be mounted into the front lens frame 103 and the rear lens frame 105. Stated differently, display assembly 108 and corresponding lens frame(s) are configured such that the display assembly 108 can be mounted to the lens frame(s) having different geometries, shapes, and/or dimensions.

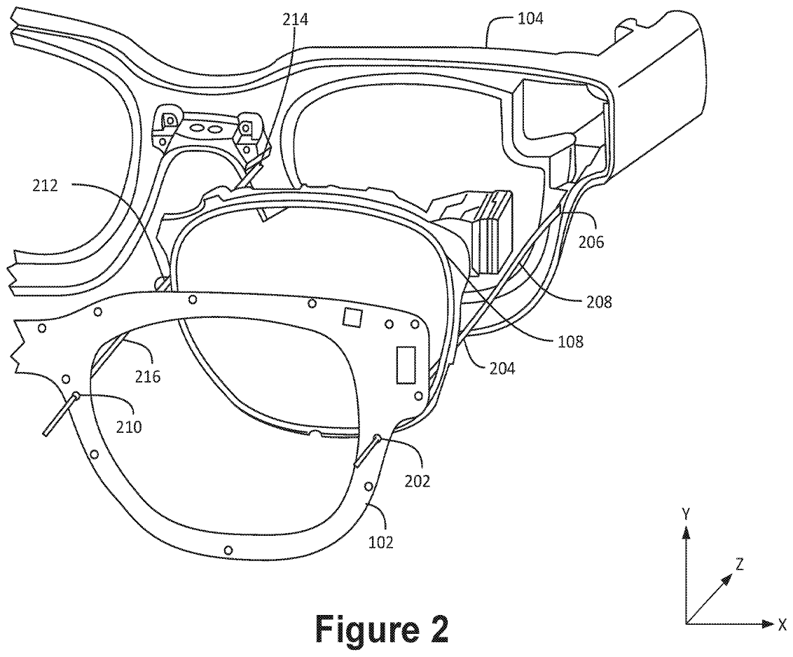

FIG. 2 illustrates an example of locating features for alignment of the display assembly and lens frames of the AR glasses, in accordance with some embodiments. The locating features described herein are universal across different (e.g., different shapes and sizes) AR glasses, thereby allowing the same modular display assembly to be assembled in the same manner across the different devices. As shown in FIG. 2, the front lens frame 102 includes a temple-locating feature 202 and a nasal-locating feature 210. Additionally, the display assembly 108 includes a temple-locating feature 204 and a nasal-locating feature 212. Further, the rear lens frame 104 includes a temple-locating feature 206 and a nasal-locating feature 214. The locating features are configured to couple together such that the front lens frame 102, the display assembly 108, and the rear lens frame 104 are aligned. In one example, the locating features of the front lens frame 102 is a socket (e.g., a hole) and the locating feature of the rear lens frame 104 is a pin (e.g., a dowel), and the socket is configured to couple to the pin such that the front lens frame 102 and the rear lens frame 104 are in the correct relative location to each other. In this example, the locating features of the display assembly 108 is a notch or hole through which the pin of the rear lens frame 104 is inserted through. When the display assembly 108 is positioned between the front lens frame 102 and the rear lens frame 104, the display assembly is held in alignment with the front and rear lens frames by the pin.

In another example, the locating features of the front lens frame 102, the rear lens frame 104, and the display assembly 108 can be through holes and/or threaded to accept fasteners (e.g., a screw, a bolt, and/or other types of fasteners). For example, the temple-locating feature 202 and the nasal-locating feature 210 of the front lens frame 102, and the temple-locating feature 204 and the nasal-locating feature 212 of the display assembly 108, are through holes. Additionally, the temple-locating feature 206 and the nasal-locating feature 214 of the rear lens frame 104 are threaded (e.g., a threaded insert). In this example, a first fastener is inserted along path 208 such that it interfaces with the temple-locating features of the front lens frame 102 and the display assembly 108 and is secured to the temple-locating feature 206 of the rear lens frame 104. Additionally, a second fastener is inserted along path 208 such that it interfaces with the nasal-locating features of the front lens frame 102 and the display assembly 108 and is secured to the nasal-locating feature 214 of the rear lens frame 104. When assembled, the combination of the locating features and the fastener align the respective components.

In some embodiments, the temple-locating features 202, 204, and 206 of the front lens frame 102, the display assembly 108, and the rear lens frame 104, respectively, are configured to enable alignment during coupling of the display assembly 108 with the front lens frame 102 and the rear lens frame 104 (e.g., enabling alignment during installation of the lens assembly to the frame of the AR glasses).

In some embodiments, the nasal-locating features 210, 212, and 214 of the front lens frame 102, the display assembly 108, and the rear lens frame 104, respectively, are configured to enable alignment during coupling of the display assembly 108 with the front lens frame 102 and the rear lens frame 104 (e.g., enabling alignment during installation of the lens assembly to the frame of the AR glasses).

In some embodiments, the temple-locating features and the nasal-locating features (in conjunction with a fixturing component when assembled with the front lens frame 102 and the rear lens frame 104) restrict movement of the display assembly 108 in an XY direction. For example, the temple-locating features and the nasal-locating features restrict lateral movement of the display assembly 108 relative to the front lens frame 102 and/or the rear lens frame 104. In some embodiments, the front lens frame 102 and/or the rear lens frame 104 restrict movement of the display assembly in a Z direction. For example, the front lens frame 102 restricts forward movement of the display assembly 108, and the rear lens frame 104 restricts rearward movement of the display assembly 108.

In some embodiments, the temple-locating features and the nasal-locating features are in the same relative positions to each other for different lens frame(s). For example, the temple-locating features and the nasal-locating features are present on both the front lens frame 102 and the rear lens frame 104 (as shown in FIG. 1A) and the front lens frame 103 and the rear lens frame 105 (as shown in FIG. 1B). In this example, the locating features are in the same relative positions such that they constrain the movement of the display assembly when mounted to a respective lens frame.

FIG. 3 illustrates an example of a lens stack 107 of the display assembly, in accordance with some embodiments. In some embodiments, the lens stack 107 includes a second visual image distance (VID2) lens 302, an adhesive 304, a waveguide 306, an adhesive 324, an eye-tracking component 308 (e.g., an eye-tracking flexible circuit) that includes electrical connectors 309 and 310, an adhesive 326, a bracket 311, an adhesive 328, a first visual image distance (VID1) glass lens 312, an adhesive 314, and a VID1 plastic lens 316.

In some embodiments, the VID1 lens(es) 312 and/or 316 adjust the image from the waveguide 306 so that the image appears a specified distance from a user, and the VID2 lens 302 counteracts the VID1 lens so that the worldview is not distorted (e.g., distorted by the VID1 lens).

In some embodiments, the VID2 lens 302, waveguide 306, VID1 glass lens 312, and/or VID1 plastic lens 316 include pin and slot systems for alignment of the aforementioned components. Further, the pin and slot system is configured to align the lens stack 107 with the front lens frame 102 and/or the rear lens frame 104 of the AR glasses.

In some embodiments, a display projector assembly 318 is configured to couple to the lens stack 107. The display projector assembly 318 may couple directly to the waveguide 306 of the lens stack 107. The display projector assembly 318 is configured to provide an image (or other optical information) to the waveguide 306 that then displays the image. For example, the display projector assembly 318 provides an image to the waveguide 306 such that a user can view the image.

In some embodiments, the display projector assembly 318 includes a liquid crystal on silicon display engine that generates light to produce the image that is projected into the waveguide 306. The waveguide 306 takes the projected image from one location (e.g., from the display projector assembly 318) and redirects the image to a user's eye(s) via a plurality of mirrors (e.g., glass components with partial mirrors).

In some embodiments, the lens stack 107 includes an active dimming component 320 (e.g., an active dimming flexible circuit). The active dimming component is configured to change transmissivity to at least increase contrast in the display image. The active dimming component can be electrochromic.

In some embodiments, the eye-tracking component 308 is configured to wrap around a frame of the AR glasses (e.g., the front lens frame 102 and/or the rear lens frame 104). For example, the eye-tracking component 308 includes a flexible circuit that includes a plurality of light emitting diodes (LEDs) that are configured to create glints on a user's pupil. These glints are captured by one or more eye-tracking cameras and processed to determine a direction that a user is looking. The eye-tracking component 308 can include an eye-tracking driver (e.g., the eye-tracking flexible circuit includes a driver component for the plurality of LEDs and/or the one or more cameras). The eye-tracking component 308 can be adhered (e.g., via glue and/or other adhesives) to other components of the display assembly 108. In some embodiments, the eye-tracking component 308 includes separate eye-tracking subcomponents (e.g., a first eye-tracking subcomponent with a first subset of LEDs and/or camera(s) and a second eye-tracking subcomponent with a second subset of LEDs and/or camera(s)).

In some embodiments, the bracket 311 includes flanges that are configured to improve drop reliability of the lens stack 107 and/or the AR glasses. Further, the bracket 311 can electrically couple to other components of the display assembly 108 (e.g., eye-tracking component 308, display projector assembly 318, and/or other components of the display assembly 108) to provide grounding for those components.

In some embodiments, one or more of the adhesives 304, 314, 324, 326, and 328 are optically transparent such that an image generated by the display assembly and displayed at the waveguide is not degraded by the adhesives.

In some embodiments, the display projector assembly 318 is configured to thermally couple to the front lens frame 102 (as shown in FIG. 1A) or front lens frame 103 (as shown in FIG. 1B) such that heat is transferred from the display projector assembly 318 to the front lens frame 102 or 103. Transferring the heat toward the front lens frame 102 or 103 increases user comfort (e.g., heat is radiated away from the user instead of toward a user). In some embodiments, graphite is used as a thermal interface between the display projector assembly 318 and a heat sink and/or radiator (e.g., the front lens frame 102 or 103). The graphite can be used with a pressure-sensitive adhesive.

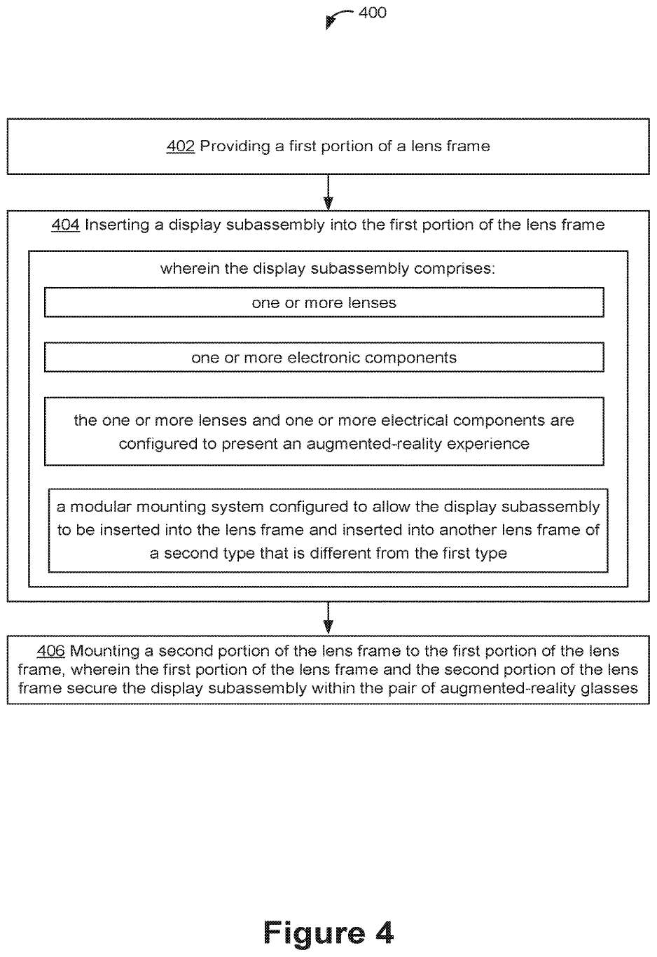

FIG. 4 illustrates a flow diagram of a method 400 of manufacturing a pair of AR glasses, in accordance with some embodiments. In some embodiments, the various operations of the methods described herein are interchangeable and/or optional. For convenience, the method operations will be described below as being performed by a particular component or device, but should not be construed as limiting the performance of the operation to the particular device in all embodiments.
(A1) In some embodiments, the method of manufacturing a pair of AR glasses (e.g., AR glasses 100 shown in FIG. 1A) includes providing 402 a first portion of a lens frame (e.g., front lens frame 102 shown in FIG. 1A) and inserting 404 a display subassembly (e.g., modular display assembly 108, which optionally includes lens stack 107 and/or display projector assembly 106, shown in FIG. 1A) into the first portion of the lens frame. The display subassembly includes one or more lenses (e.g., lens stack 107, shown in FIGS. 1A and 3) and one or more electrical components (e.g., display projector assembly 106, disparity sensor assembly 110, eye-tracking component 308, and/or active dimming component 320 shown in FIGS. 1A and 3) that are configured to present an AR experience. The display subassembly further includes a modular mounting system (e.g., locating features 204 and 212 shown in FIG. 2) that is configured to allow the display subassembly to be inserted into the lens frame and inserted into another lens frame of a second type that is different from the first type. For example, the modular mounting system is configured to allow the display subassembly to be inserted into a first pair of glasses and inserted into a second pair of glasses that is distinct from the first pair of glasses. The second pair of glasses can differ from the first pair of glasses in shape, size, and/or other physical parameters.
(A2) In some embodiments of A1, the method of manufacture of AR glasses further includes mounting 406 a second portion of the lens frame (e.g., rear lens frame 104 shown in FIG. 1A) to the first portion of the lens frame such that the display subassembly is secured within the pair of AR glasses. For example, the display subassembly is in between (e.g., sandwiched between) the first portion of the lens frame and the second portion of the lens frame.
(A3) In some embodiments of any of A1-A2, the display subassembly is configured in accordance with the display assembly corresponding to any of embodiments B1-B11.
(B1) In accordance with some embodiments, a display assembly includes one or more lenses and one or more electrical components that are configured to present an AR experience at a pair of AR glasses. The display assembly further includes a modular mounting system that is configured to allow the display assembly to be inserted into a lens frame of a first type having a first shape and inserted into a lens frame of a second type having a second shape that is different from the first shape. For example, the modular mounting system is configured to allow the display assembly to be inserted into a first pair of glasses that is square and inserted into a second pair of glasses that is heart-shaped. The second pair of glasses can differ from the first pair of glasses in other ways, such as size, materials, and/or other physical parameters.
(B2) In some embodiments of B1, the lens frame of the first type is configured to secure the first display assembly within a first pair of AR glasses and the lens frame of the second type is configured to secure the first display assembly within a second pair of AR glasses. The lens frame of the first type is distinct from the lens frame of the second type.
(B3) In some embodiments of any of B1-B2, the display assembly includes one or more locating features (e.g., temple-locating features 202 and 204 and nasal-locating features 210 and 212 shown in FIG. 2) that are configured to align the display assembly to the lens frame of the first type and configured to align the display assembly to the lens frame of the second type.
(B4) In some embodiments of any of B1-B3, the modular mounting system includes adhesive (e.g., a pressure-sensitive adhesive) configured to allow the display assembly to be coupled to the lens frame of the first type and coupled to the lens frame of the second type.
(B5) In some embodiments of any of B1-B4, the display assembly includes a display projection device (e.g., display projector assembly 318 shown in FIG. 3, such as a liquid crystal on silicon (LCoS) based display engine), a waveguide (e.g., waveguide 306 shown in FIG. 3), a first lens (e.g., VID1 lens(es) 312 and/or 316 shown in FIG. 3), a second lens (e.g., VID2 lens 302 shown in FIG. 3), and an eye-tracking device (e.g., eye-tracking component 308 shown in FIG. 3). In some embodiments, the waveguide is a geometric reflective waveguide, the first lens is a plano-concave lens, and the second lens is a plano-convex lens. The first lens and the second lens can be configured such that the worldview through a combination of the two lenses is minimally or not distorted. The eye-tracking device includes a plurality of LEDs and one or more cameras to capture reflections (e.g., glints) of the light emitted from the plurality of LEDs from a user's pupil.
(B6) In some embodiments of any of B1-B5, the display projection device is configured to be coupled to the lens frame of the first type and the lens frame of the second type via an adhesive that is configured to dampen vibrations from a respective lens frame to the display projection device.
(B7) In some embodiments of any of B1-B6, the display projection device is configured to be thermally coupled to the lens frame of the first type and the lens frame of the second type via a thermally conductive material to transfer heat generated by the display projection device to a respective lens frame.
(B8) In some embodiments of any of B1-B7, the display projection device is configured to be thermally coupled to the lens frame of the first type and the lens frame of the second type via a thermally conductive material to transfer heat generated by the display projection device to a respective lens frame.
(B9) In some embodiments of any of B1-B8, the display projection device is electrically coupled to additional components of the AR glasses, such as one or more batteries, cameras, or sensors via a flexible circuit (e.g., first connector 112 and/or second connector 114 shown in FIG. 1A). Examples of sensors include disparity sensors, inertial measurement units, geolocation sensors, temperature sensors, and/or other types of sensors.
(B10) In some embodiments of any of B1-B9, the display assembly is a first display assembly that includes a second display assembly distinct from the first display assembly (e.g., the right display assembly 108 shown in FIG. 1A). The second display assembly includes one or more lenses of the second display assembly and one or more electronic components of the second display assembly that are configured to present an AR experience at the pair of AR glasses. The second display assembly also includes a modular mounting system of the second display assembly configured to allow the second display assembly to be inserted into the lens frame of a first type and inserted into the lens frame of a second type.

In some embodiments, the first portion of the lens frame of the first type or the second type is configured to be proximate to a user's left eye, and the second portion of the lens frame of the first type or the second type is configured to be proximate to the user's right eye when respective AR glasses are donned. As such, a first display assembly that is inserted into the first portion of the lens frame of the first type or the second type is within the viewing region of the user's left eye when the respective AR glasses are donned, and a second display assembly that is inserted into the second portion of the lens frame of the first type or the second type is within the viewing region of the user's right eye when the respective AR glasses are donned.
(B11) In some embodiments of any of B1-B10, the display assembly includes a disparity sensing device configured to be coupled to the lens frame of the first type and the lens frame of the second type. The disparity sensing device is configured to detect disparity between the first lens assembly and the second lens assembly based on visual information received from the first display assembly and the second display assembly.
(C1) In accordance with some embodiments, a pair of AR glasses is configured corresponding to any of B1-B11.
(D1) In accordance with some embodiments, a display subassembly of a pair of AR glasses is configured corresponding to any of B1-B11.

### Example Extended—Reality Systems

FIGS. 5A, 5B, 5C-1, and 5C-2 illustrate example XR systems that include AR and MR systems, in accordance with some embodiments. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor and/or a time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive, and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, or services, or some combination thereof, that are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and/or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device or an external tracking camera that is set up in the surrounding environment)). “In-air” generally includes gestures in which the user's hand does not contact a surface, object, or portion of an electronic device (e.g., a head-wearable device or other communicatively coupled device, such as the wrist-wearable device); in other words, the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, and/or a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, and/or strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting, and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)) is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, or other non-volatile solid state storage devices that can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO2) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein, biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramansors configured to measure electrical activity of the heart to diagnose heart problems; (iii) EMG sensors configured to measure the electrical activity of muscles and diagnose neuromuscular disorders; and (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

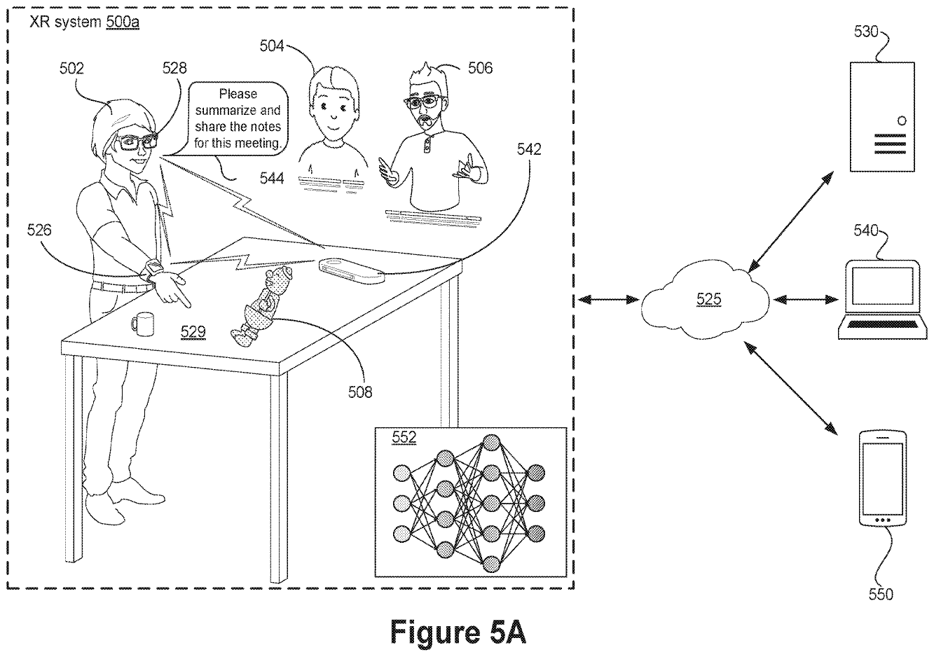

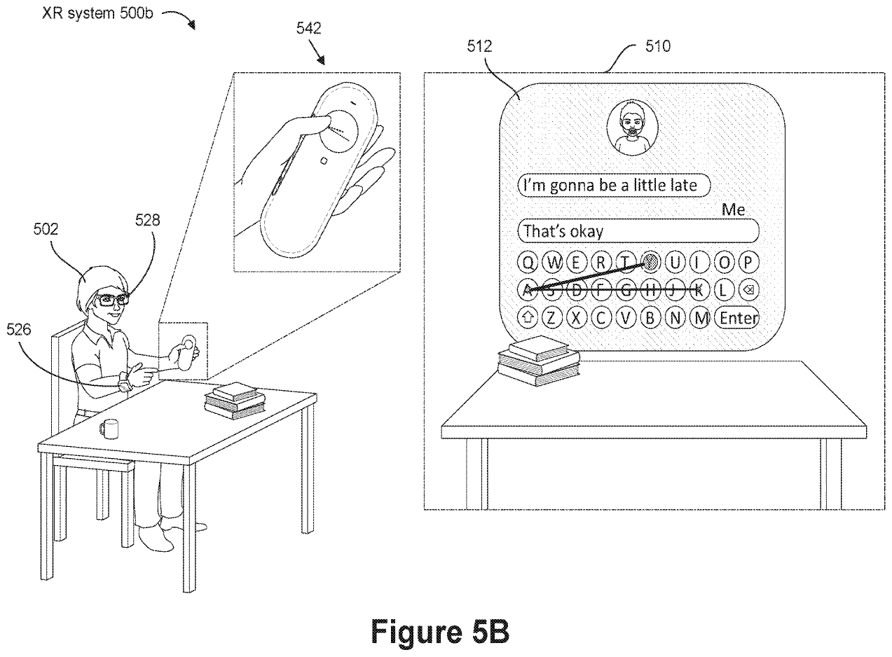

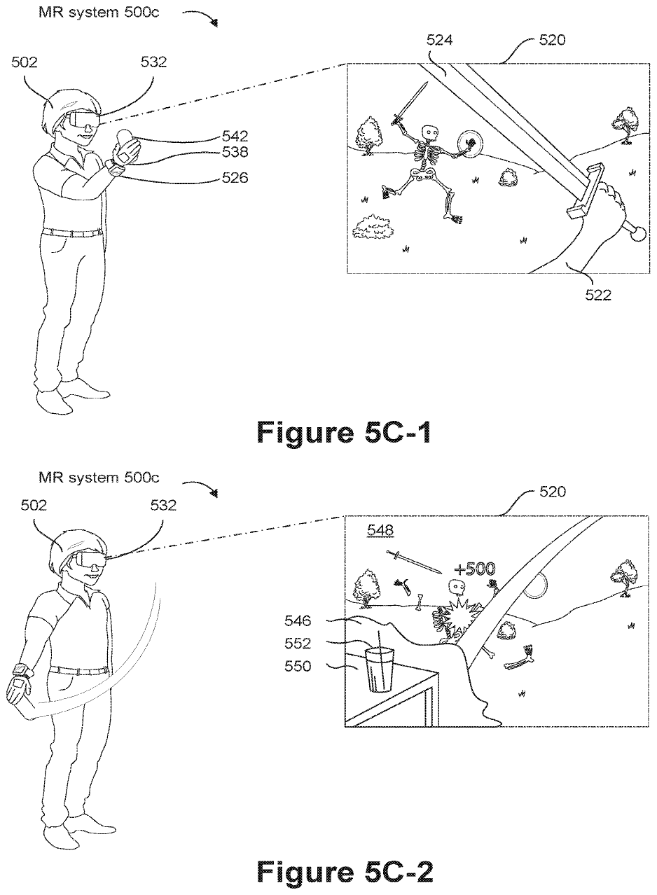

As described herein, non-transitory computer-readable storage media are physical devices or storage media that can be used to store electronic data in a non-transitory form (e.g., such that the data is stored permanently until it is intentionally deleted and/or modified). FIG. 5A shows a first XR system 500a and first example user interactions using a wrist-wearable device 526, a head-wearable device (e.g., AR device 528), and/or an HIPD 542. FIG. 5B shows a second XR system 500b and second example user interactions using a wrist-wearable device 526, an AR device 528, and/or an HIPD 542. FIGS. 5C-1 and 5C-2 show a third MR system 500c and third example user interactions using a wrist-wearable device 526, a head-wearable device (e.g., an MR device such as a VR device), and/or an HIPD 542. As the skilled artisan will appreciate upon reading the descriptions provided herein, the above-example AR and MR systems (described in detail below) can perform various functions and/or operations.

The wrist-wearable device 526, the head-wearable devices, and/or the HIPD 542 can communicatively couple via a network 525 (e.g., cellular, near field, Wi-Fi, personal area network, and/or wireless LAN). Additionally, the wrist-wearable device 526, the head-wearable device, and/or the HIPD 542 can also communicatively couple with one or more servers 530, computers 540 (e.g., laptops, computers), mobile devices 550 (e.g., smartphones, tablets), and/or other electronic devices via the network 525 (e.g., cellular, near field, Wi-Fi, personal area network, and/or wireless LAN). Similarly, a smart textile-based garment, when used, can also communicatively couple with the wrist-wearable device 526, the head-wearable device(s), the HIPD 542, the one or more servers 530, the computers 540, the mobile devices 550, and/or other electronic devices via the network 525 to provide inputs.

Turning to FIG. 5A, a user 502 is shown wearing the wrist-wearable device 526 and the AR device 528 and having the HIPD 542 on their desk. The wrist-wearable device 526, the AR device 528, and the HIPD 542 facilitate user interaction with an AR environment. In particular, as shown by the first XR system 500a, the wrist-wearable device 526, the AR device 528, and/or the HIPD 542 cause presentation of one or more avatars 504, digital representations of contacts 506, and virtual objects 508. As discussed below, the user 502 can interact with the one or more avatars 504, digital representations of the contacts 506, and virtual objects 508 via the wrist-wearable device 526, the AR device 528, and/or the HIPD 542. In addition, the user 502 is also able to directly view physical objects in the environment, such as a physical table 529, through transparent lens(es) and waveguide(s) of the AR device 528. Alternatively, an MR device could be used in place of the AR device 528 and a similar user experience can take place, but the user would not be directly viewing physical objects in the environment, such as the table 529, and would instead be presented with a virtual reconstruction of the table 529 produced from one or more sensors of the MR device (e.g., an outward-facing camera capable of recording the surrounding environment).

The user 502 can use any of the wrist-wearable device 526, the AR device 528 (e.g., through physical inputs at the AR device and/or built-in motion tracking of a user's extremities), a smart-textile garment, an externally mounted extremity tracking device, the HIPD 542 to provide user inputs, etc. For example, the user 502 can perform one or more hand gestures that are detected by the wrist-wearable device 526 (e.g., using one or more EMG sensors and/or IMUs built into the wrist-wearable device) and/or AR device 528 (e.g., using one or more image sensors or cameras) to provide a user input. Alternatively, or additionally, the user 502 can provide a user input via one or more touch surfaces of the wrist-wearable device 526, the AR device 528, and/or the HIPD 542, and/or voice commands captured by a microphone of the wrist-wearable device 526, the AR device 528, and/or the HIPD 542. The wrist-wearable device 526, the AR device 528, and/or the HIPD 542 include an artificially intelligent digital assistant to help the user in providing a user input (e.g., completing a sequence of operations, suggesting different operations or commands, providing reminders, and/or confirming a command). For example, the digital assistant can be invoked through an input occurring at the AR device 528 (e.g., via an input at a temple arm of the AR device 528). In some embodiments, the user 502 can provide a user input via one or more facial gestures and/or facial expressions. For example, cameras of the wrist-wearable device 526, the AR device 528, and/or the HIPD 542 can track the user 502's eyes for navigating a user interface.

The wrist-wearable device 526, the AR device 528, and/or the HIPD 542 can operate alone or in conjunction to allow the user 502 to interact with the AR environment. In some embodiments, the HIPD 542 is configured to operate as a central hub or control center for the wrist-wearable device 526, the AR device 528, and/or another communicatively coupled device. For example, the user 502 can provide an input to interact with the AR environment at any of the wrist-wearable device 526, the AR device 528, and/or the HIPD 542, and the HIPD 542 can identify one or more back-end and front-end tasks to cause the performance of the requested interaction and distribute instructions to cause the performance of the one or more back-end and front-end tasks at the wrist-wearable device 526, the AR device 528, and/or the HIPD 542. In some embodiments, a back-end task is a background-processing task that is not perceptible by the user (e.g., rendering content, decompression, compression, and/or application-specific operations), and a front-end task is a user-facing task that is perceptible to the user (e.g., presenting information to the user and/or providing feedback to the user). The HIPD 542 can perform the back-end tasks and provide the wrist-wearable device 526 and/or the AR device 528 operational data corresponding to the performed back-end tasks such that the wrist-wearable device 526 and/or the AR device 528 can perform the front-end tasks. In this way, the HIPD 542, which has more computational resources and greater thermal headroom than the wrist-wearable device 526 and/or the AR device 528, performs computationally intensive tasks and reduces the computer resource utilization and/or power usage of the wrist-wearable device 526 and/or the AR device 528.

In the example shown by the first XR system 500a, the HIPD 542 identifies one or more back-end tasks and front-end tasks associated with a user request to initiate an AR video call with one or more other users (represented by the avatar 504 and the digital representation of the contact 506) and distributes instructions to cause the performance of the one or more back-end tasks and front-end tasks. In particular, the HIPD 542 performs back-end tasks for processing and/or rendering image data (and other data) associated with the AR video call and provides operational data associated with the performed back-end tasks to the AR device 528 such that the AR device 528 performs front-end tasks for presenting the AR video call (e.g., presenting the avatar 504 and the digital representation of the contact 506).

In some embodiments, the HIPD 542 can operate as a focal or anchor point for causing the presentation of information. This allows the user 502 to be generally aware of where information is presented. For example, as shown in the first XR system 500a, the avatar 504 and the digital representation of the contact 506 are presented above the HIPD 542. In particular, the HIPD 542 and the AR device 528 operate in conjunction to determine a location for presenting the avatar 504 and the digital representation of the contact 506. In some embodiments, information can be presented within a predetermined distance from the HIPD 542 (e.g., within five meters). For example, as shown in the first XR system 500a, virtual object 508 is presented on the desk some distance from the HIPD 542. Similar to the above example, the HIPD 542 and the AR device 528 can operate in conjunction to determine a location for presenting the virtual object 508. Alternatively, in some embodiments, presentation of information is not bound by the HIPD 542. More specifically, the avatar 504, the digital representation of the contact 506, and the virtual object 508 do not have to be presented within a predetermined distance of the HIPD 542. While an AR device 528 is described working with an HIPD, an MR headset can be interacted with in the same way as the AR device 528.

User inputs provided at the wrist-wearable device 526, the AR device 528, and/or the HIPD 542 are coordinated such that the user can use any device to initiate, continue, and/or complete an operation. For example, the user 502 can provide a user input to the AR device 528 to cause the AR device 528 to present the virtual object 508 and, while the virtual object 508 is presented by the AR device 528, the user 502 can provide one or more hand gestures via the wrist-wearable device 526 to interact and/or manipulate the virtual object 508. While an AR device 528 is described working with a wrist-wearable device 526, an MR headset can be interacted with in the same way as the AR device 528.

### Integration of Artificial Intelligence With XR Systems

FIG. 5A illustrates an interaction in which an artificially intelligent virtual assistant can assist in requests made by a user 502. The AI virtual assistant can be used to complete open-ended requests made through natural language inputs by a user 502. For example, in FIG. 5A, the user 502 makes an audible request 544 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 5A also illustrates an example neural network 552 used in Artificial Intelligence applications. Uses of Artificial Intelligence (AI) are varied and encompass many different aspects of the devices and systems described herein. AI capabilities cover a diverse range of applications and deepen interactions between the user 502 and user devices (e.g., the AR device 528, an MR device 532, the HIPD 542, and/or the wrist-wearable device 526). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models, and based on the user's request, multiple AI models can be employed (concurrently, sequentially or a combination thereof). For example, an LLM-based AI model can provide instructions for helping a user follow a recipe and the instructions can be based in part on another AI model that is derived from an ANN, a DNN, an RNN, etc., that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 502 can interact with an AI model through natural language inputs captured by a voice sensor, text inputs, or any other input modality that accepts natural language and/or a corresponding voice sensor module. In another instance, input is provided by tracking the eye gaze of a user 502 via a gaze tracker module. Additionally, the AI model can also receive inputs beyond those supplied by a user 502. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, and/or sleep data) captured in response to a user request by various types of sensors and/or their corresponding sensor modules. The sensors' data can be retrieved entirely from a single device (e.g., AR device 528) or from multiple devices that are in communication with each other (e.g., a system that includes at least two of an AR device 528, an MR device 532, the HIPD 542, the wrist-wearable device 526, etc.). The AI model can also access additional information (e.g., one or more servers 530, the computers 540, the mobile devices 550, and/or other electronic devices) via a network 525.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 528, an MR device 532, the HIPD 542, and/or the wrist-wearable device 526) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 528, an MR device 532, the HIPD 542, and/or the wrist-wearable device 526), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, and/or user interfaces displayed at a wrist-wearable device, laptop device, mobile device, etc. On devices with or without displays (e.g., HIPD 542), haptic feedback can provide information to the user 502. An AI model can also use the inputs described above to determine the appropriate modality and device(s) to present content to the user (e.g., a user walking on a busy road can be presented with an audio output instead of a visual output to avoid distracting the user 502).

### Example AR Interaction

FIG. 5B shows the user 502 wearing the wrist-wearable device 526 and the AR device 528 and holding the HIPD 542. In the second XR system 500b, the wrist-wearable device 526, the AR device 528, and/or the HIPD 542 are used to receive and/or provide one or more messages to a contact of the user 502. In particular, the wrist-wearable device 526, the AR device 528, and/or the HIPD 542 detect and coordinate one or more user inputs to initiate a messaging application and prepare a response to a received message via the messaging application.

In some embodiments, the user 502 initiates, via a user input, an application on the wrist-wearable device 526, the AR device 528, and/or the HIPD 542 that causes the application to initiate on at least one device. For example, in the second XR system 500b, the user 502 performs a hand gesture associated with a command for initiating a messaging application (represented by messaging user interface 512). The wrist-wearable device 526 detects the hand gesture and, based on a determination that the user 502 is wearing the AR device 528, causes the AR device 528 to present a messaging user interface 512 of the messaging application. The AR device 528 can present the messaging user interface 512 to the user 502 via its display (e.g., as shown by user 502's field of view 510). In some embodiments, the application is initiated and can be run on the device (e.g., the wrist-wearable device 526, the AR device 528, and/or the HIPD 542) that detects the user input to initiate the application, and the device provides another device operational data to cause the presentation of the messaging application. For example, the wrist-wearable device 526 can detect the user input to initiate a messaging application, initiate and run the messaging application, and provide operational data to the AR device 528 and/or the HIPD 542 to cause presentation of the messaging application. Alternatively, the application can be initiated and run at a device other than the device that detected the user input. For example, the wrist-wearable device 526 can detect the hand gesture associated with initiating the messaging application and cause the HIPD 542 to run the messaging application and coordinate the presentation of the messaging application.

Further, the user 502 can provide a user input provided at the wrist-wearable device 526, the AR device 528, and/or the HIPD 542 to continue and/or complete an operation initiated at another device. For example, after initiating the messaging application via the wrist-wearable device 526 and while the AR device 528 presents the messaging user interface 512, the user 502 can provide an input at the HIPD 542 to prepare a response (e.g., shown by the swipe gesture performed on the HIPD 542). The user 502's gestures performed on the HIPD 542 can be provided and/or displayed on another device. For example, the user 502's swipe gestures performed on the HIPD 542 are displayed on a virtual keyboard of the messaging user interface 512 displayed by the AR device 528.

In some embodiments, the wrist-wearable device 526, the AR device 528, the HIPD 542, and/or other communicatively coupled devices can present one or more notifications to the user 502. The notification can be an indication of a new message, an incoming call, an application update, a status update, etc. The user 502 can select the notification via the wrist-wearable device 526, the AR device 528, or the HIPD 542 and cause presentation of an application or operation associated with the notification on at least one device. For example, the user 502 can receive a notification that a message was received at the wrist-wearable device 526, the AR device 528, the HIPD 542, and/or another communicatively coupled device and provide a user input at the wrist-wearable device 526, the AR device 528, and/or the HIPD 542 to review the notification, and the device detecting the user input can cause an application associated with the notification to be initiated and/or presented at the wrist-wearable device 526, the AR device 528, and/or the HIPD 542.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 528 can present to the user 502 game application data and the HIPD 542 can use a controller to provide inputs to the game. Similarly, the user 502 can use the wrist-wearable device 526 to initiate a camera of the AR device 528, and the user can use the wrist-wearable device 526, the AR device 528, and/or the HIPD 542 to manipulate the image capture (e.g., zoom in or out, and/or apply filters) and capture image data.

While an AR device 528 is shown being capable of certain functions, it is understood that an AR device can be an AR device with varying functionalities based on costs and market demands. For example, an AR device can include a single output modality such as an audio output modality. In another example, the AR device can include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side lens can illuminate to notify the wearer to turn left while directions are being provided. In another embodiment, the AR device can include an outward-facing projector such that information (e.g., text information and/or media) can be displayed on the palm of a user's hand or another suitable surface (e.g., a table or a whiteboard). In yet another embodiment, information can also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed to presenting an AR augmented at both lenses to produce a binocular image). In some instances, an AR device capable of presenting AR augments binocularly can optionally display AR augments monocularly as well (e.g., for power-saving purposes or other presentation considerations). These examples are non-exhaustive, and features of one AR device described above can be combined with features of another AR device described above. While features and experiences of an AR device have been described generally in the preceding sections, it is understood that the described functionalities and experiences can be applied in a similar manner to an MR headset, which is described below in the following sections.

### Example Mixed Reality Interaction

Turning to FIGS. 5C-1 and 5C-2, the user 502 is shown wearing the wrist-wearable device 526 and an MR device 532 (e.g., a device capable of providing either an entirely VR experience or an MR experience that displays object(s) from a physical environment at a display of the device) and holding the HIPD 542. In the third MR system 500c, the wrist-wearable device 526, the MR device 532, and/or the HIPD 542 are used to interact within an MR environment, such as a VR game or other MR/VR application. While the MR device 532 presents a representation of a VR game (e.g., first MR game environment 520) to the user 502, the wrist-wearable device 526, the MR device 532, and/or the HIPD 542 detect and coordinate one or more user inputs to allow the user 502 to interact with the VR game.

In some embodiments, the user 502 can provide a user input via the wrist-wearable device 526, the MR device 532, and/or the HIPD 542 that causes an action in a corresponding MR environment. For example, the user 502 in the third MR system 500c (shown in FIG. 5C-1) raises the HIPD 542 to prepare for a swing in the first MR game environment 520. The MR device 532, responsive to the user 502 raising the HIPD 542, causes the MR representation of the user 522 to perform a similar action (e.g., raise a virtual object, such as a virtual sword 524). In some embodiments, each device uses respective sensor data and/or image data to detect the user input and provide an accurate representation of the user 502's motion. For example, image sensors (e.g., SLAM cameras or other cameras) of the HIPD 542 can be used to detect a position of the HIPD 542 relative to the user 502's body such that the virtual object can be positioned appropriately within the first MR game environment 520, sensor data from the wrist-wearable device 526 can be used to detect a velocity at which the user 502 raises the HIPD 542 such that the MR representation of the user 522 and the virtual sword 524 are synchronized with the user 502's movements, and image sensors of the MR device 532 can be used to represent the user 502's body, boundary conditions, or real-world objects within the first MR game environment 520.

In FIG. 5C-2, the user 502 performs a downward swing while holding the HIPD 542. The user 502's downward swing is detected by the wrist-wearable device 526, the MR device 532, and/or the HIPD 542 and a corresponding action is performed in the first MR game environment 520. In some embodiments, the data captured by each device is used to improve the user's experience within the MR environment. For example, sensor data of the wrist-wearable device 526 can be used to determine a speed and/or force at which the downward swing is performed and image sensors of the HIPD 542 and/or the MR device 532 can be used to determine a location of the swing and how it should be represented in the first MR game environment 520, which, in turn, can be used as inputs for the MR environment (e.g., game mechanics, which can use detected speed, force, locations, and/or aspects of the user 502's actions to classify a user's inputs (e.g., user performs a light strike, hard strike, critical strike, glancing strike, and/or miss) or calculate an output (e.g., amount of damage)).

FIG. 5C-2 further illustrates that a portion of the physical environment is reconstructed and displayed at a display of the MR device 532 while the MR game environment 520 is being displayed. In this instance, a reconstruction of the physical environment 546 is displayed in place of a portion of the MR game environment 520 when object(s) in the physical environment are potentially in the path of the user (e.g., a collision with the user and an object in the physical environment are likely). Thus, this example MR game environment 520 includes (i) an immersive VR portion 548 (e.g., an environment that does not have a corollary counterpart in a nearby physical environment) and (ii) a reconstruction of the physical environment 546 (e.g., table 550 and cup 552). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 526, the MR device 532, and/or the HIPD 542 are described as detecting user inputs, in some embodiments, user inputs are detected at a single device (with the single device being responsible for distributing signals to the other devices for performing the user input). For example, the HIPD 542 can operate an application for generating the first MR game environment 520 and provide the MR device 532 with corresponding data for causing the presentation of the first MR game environment 520, as well as detect the user 502's movements (while holding the HIPD 542) to cause the performance of corresponding actions within the first MR game environment 520. Additionally or alternatively, in some embodiments, operational data (e.g., sensor data, image data, application data, device data, and/or other data) of one or more devices is provided to a single device (e.g., the HIPD 542) to process the operational data and cause respective devices to perform an action associated with processed operational data.

In some embodiments, the user 502 can wear a wrist-wearable device 526, wear an MR device 532, wear smart textile-based garments 538 (e.g., wearable haptic gloves), and/or hold an HIPD 542 device. In this embodiment, the wrist-wearable device 526, the MR device 532, and/or the smart textile-based garments 538 are used to interact within an MR environment (e.g., any AR or MR system described above in reference to FIGS. 5A-5B). While the MR device 532 presents a representation of an MR game (e.g., second MR game environment 520) to the user 502, the wrist-wearable device 526, the MR device 532, and/or the smart textile-based garments 538 detect and coordinate one or more user inputs to allow the user 502 to interact with the MR environment.

In some embodiments, the user 502 can provide a user input via the wrist-wearable device 526, an HIPD 542, the MR device 532, and/or the smart textile-based garments 538 that causes an action in a corresponding MR environment. In some embodiments, each device uses respective sensor data and/or image data to detect the user input and provide an accurate representation of the user 502's motion. While four different input devices are shown (e.g., a wrist-wearable device 526, an MR device 532, an HIPD 542, and a smart textile-based garment 538), each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 538), sensor fusion can be utilized to ensure that inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 538 can be used in conjunction with an MR device and/or an HIPD 542.

While some experiences are described as occurring on an AR device and other experiences are described as occurring on an MR device, one skilled in the art would appreciate that experiences can be ported over from an MR device to an AR device, and vice versa.

In some aspects, the subject technology is directed to a display assembly comprising one or more lenses, one or more electronic components, and a modular mounting system to allow the display assembly to fit into different lens frames of different types. The one or more lenses and one or more electronic components are configured to present an augmented-reality experience at an extended-reality (XR) device.

In some implementations, the display assembly is configured to be used in an XR device including a mixed reality (MR) headset, a virtual reality headset and a pair of augmented reality (AR) glasses.

In some implementations, the different lens frames of different types comprise a lens frame of a first type and a lens frame of a second type.

In some implementations, the lens frame of the first type comprises first properties including a first shape and a first material and includes a first front lens frame and a first rear lens frame.

In some implementations, the lens frame of the second type comprises second properties including a second shape and a second material and includes a second front lens frame and a second rear lens frame.

In some implementations, the display assembly is configured to be coupled to a display projector device.

In some implementations, the display projection device is configured to be thermally coupled to the different lens frames of different types via a thermally conductive material to transfer heat generated by the display projection device to a respective lens frame.

In some implementations, the display assembly is configured to be coupled to one or more sensors including one or more disparity sensors, inertial measurement units, geolocation sensors and temperature sensors.

In some implementations, the display assembly is configured to be coupled to an eye-tracking component and an active dimming component.

In other aspects, the subject technology is directed to an AR device comprising a display assembly that includes a lens stack including one or more lenses, one or more electronic components configured to process images from the lens stack to present an augmented-reality experience, and a modular mounting system configured to allow the display assembly to fit into different lens frames of different types.

In some implementations, the different lens frames of different types comprise a lens frame of a first type and a lens frame of a second type.

In some implementations, the lens frame of the first type comprises first properties including a first shape and a first material and includes a first front lens frame and a first rear lens frame.

In some implementations, the lens frame of the second type comprises second properties including a second shape and a second material and includes a second front lens frame and a second rear lens frame.

In some implementations, the display assembly is configured to be coupled to a display projector device that is configured to be thermally coupled to the different lens frames via a thermally conductive material to transfer heat generated by the display projection device to a respective lens frame.

In some implementations, the display assembly is configured to be coupled to one or more sensors including one or more disparity sensors, inertial measurement units, geolocation sensors and temperature sensors.

In some implementations, the display assembly is configured to be coupled to an eye-tracking component and an active dimming component.

In yet other aspects, the subject technology is directed to a method comprising providing a first portion of a lens frame, inserting a display assembly into the first portion of the lens frame, and mounting a second portion of the lens frame to the first portion of the lens frame. The first portion of a lens frame and the second portion of the lens frame are configured to secure the display assembly within an XR device. The display assembly includes one or more lenses and one or more electronic components configured to present an XR reality at the XR device, and a modular mounting system configured to allow the display assembly to fit into a lens frame of a first type and a lens frame of a second type.

In some implementations, the lens frame of the first type comprises first properties including a first shape and a first material and includes a first front lens frame and a first rear lens frame.

In some implementations, the lens frame of the second type comprises second properties including a second shape and a second material and includes a second front lens frame and a second rear lens frame.

In some implementations, the method further comprises configuring the display assembly to be coupled to a display projector device, one or more sensors including one or more disparity sensors, inertial measurement units, geolocation sensors and temperature sensors, an eye-tracking component and an active dimming component.

Some definitions of devices and components that can be included in some or all of the example devices discussed are defined here for ease of reference. A skilled artisan will appreciate that certain types of the components described can be more suitable for a particular set of devices, and less suitable for a different set of devices. But subsequent references to the components defined here should be considered to be encompassed by the definitions provided.

In some embodiments, example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices, and facilitates communication and/or data processing and/or data transfer between the respective electronic devices and/or electronic components.

The foregoing descriptions of FIGS. 5A-5C-2 provided above are intended to augment the description provided in reference to FIGS. 1-4. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc., may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

1. (canceled)

2. A display assembly, comprising:
one or more lenses;
one or more electronic components; and
a modular mounting system configured to allow the display assembly to fit into different lens frames of different types,
wherein the one or more lenses and one or more electronic components are configured to present an augmented-reality experience at an extended-reality (XR) device.

3. The display assembly of claim 2, wherein the display assembly is configured to be used in an XR device including a mixed reality (MR) headset, a virtual reality headset and a pair of augmented reality (AR) glasses.

4. The display assembly of claim 2, wherein the different lens frames of different types comprise a lens frame of a first type and a lens frame of a second type.

5. The display assembly of claim 4, wherein the lens frame of the first type comprises first properties including a first shape and a first material and includes a first front lens frame and a first rear lens frame.

6. The display assembly of claim 4, wherein the lens frame of the second type comprises second properties including a second shape and a second material and includes a second front lens frame and a second rear lens frame.

7. The display assembly of claim 2, wherein the display assembly is configured to be coupled to a display projector device.

8. The display assembly of claim 7, wherein the display projection device is configured to be thermally coupled to the different lens frames of different types via a thermally conductive material to transfer heat generated by the display projection device to a respective lens frame.

9. The display assembly of claim 2, wherein the display assembly is configured to be coupled to one or more sensors including one or more disparity sensors, inertial measurement units, geolocation sensors and temperature sensors.

10. The display assembly of claim 2, wherein the display assembly is configured to be coupled to an eye-tracking component and an active dimming component.

11. An AR device, comprising:
a display assembly, comprising:
a lens stack including one or more lenses;
one or more electronic components configured to process images from the lens stack to present an augmented-reality experience; and
a modular mounting system configured to allow the display assembly to fit into different lens frames of different types.

12. The AR device of claim 11, wherein the different lens frames of different types comprise a lens frame of a first type and a lens frame of a second type.

13. The AR device of claim 12, wherein the lens frame of the first type comprises first properties including a first shape and a first material and includes a first front lens frame and a first rear lens frame.

14. The AR device of claim 12, wherein the lens frame of the second type comprises second properties including a second shape and a second material and includes a second front lens frame and a second rear lens frame.

15. The AR device of claim 11, wherein the display assembly is configured to be coupled to a display projector device that is configured to be thermally coupled to the different lens frames via a thermally conductive material to transfer heat generated by the display projection device to a respective lens frame.

16. The AR device of claim 15, wherein the display assembly is configured to be coupled to one or more sensors including one or more disparity sensors, inertial measurement units, geolocation sensors and temperature sensors.

17. The AR device of claim 11, wherein the display assembly is configured to be coupled to an eye-tracking component and an active dimming component.

18. A method comprising:
providing a first portion of a lens frame;
inserting a display assembly into the first portion of the lens frame; and
mounting a second portion of the lens frame to the first portion of the lens frame, wherein:
the first portion of a lens frame and the second portion of the lens frame are configured to secure the display assembly within an XR device, and
the display assembly comprises:
one or more lenses and one or more electronic components configured to present an XR reality at the XR device; and
a modular mounting system configured to allow the display assembly to fit into a lens frame of a first type and a lens frame of a second type.

19. The method of claim 18, wherein the lens frame of the first type comprises first properties including a first shape and a first material and includes a first front lens frame and a first rear lens frame.

20. The method of claim 18, wherein the lens frame of the second type comprises second properties including a second shape and a second material and includes a second front lens frame and a second rear lens frame.

21. The method of claim 18, further comprising configuring the display assembly to be coupled to a display projector device, one or more sensors including one or more disparity sensors, inertial measurement units, geolocation sensors and temperature sensors, an eye-tracking component and an active dimming component.
